(19) United States
(12) Patent Application Publication
(10) Pub. No.: US 2026/0154348 A1
(43) Pub. Date: Jun. 4, 2026

(54) DATA COLLECTION TO DETERMINE USER CONTENT STYLE PREFERENCES

(71) Applicant: AT&T Intellectual Property I, L.P., Atlanta, GA (US)

(72) Inventors: Gregory W. Edwards, Austin, TX (US); James H. Pratt, Round Rock, TX (US); Eric Zavesky, Austin, TX (US); Ari Craine, Marietta, GA (US); Robert Moton, JR., Alpharetta, GA (US); Adrianne Binh Luu, Atlanta, GA (US); Robert Koch, Norcross, GA (US)

(73) Assignee: AT&T Intellectual Property I, L.P., Atlanta, GA (US)

(21) Appl. No.: 18/964,987

(22) Filed: Dec. 2, 2024

(51) Int. Cl. G06F 16/9035; G06F 3/01

(52) U.S. Cl. CPC G06F 16/9035; G06F 3/013

(57) ABSTRACT

Aspects of the subject disclosure may include, for example, receiving data describing a consumption of first content data by a user at a user device, determining content style preferences of the user, wherein the determining the content style preferences for the user is based on the data describing the consumption of the first content data by the user, receiving second content data for the user, and modifying the second content data for the user, forming a modified content item, wherein the modifying the second content data is based on the content style preferences of the user. Other embodiments are disclosed.

### FIELD OF THE DISCLOSURE

The subject disclosure relates to a method and system for data collection to determine content style preferences of a user.

### BACKGROUND

Users of communication networks and data networks access a wide variety of data sources and view content in a wide variety of formats and styles. This has created a problem for users who have a style presentation preference for content items viewed on a user device of the user.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communications network of FIG. 1 and in conjunction with one or more sensors in accordance with various aspects described herein.

FIG. 2C is a block diagram illustrating an example, non-limiting embodiment of a sensor functioning within the communications network of FIG. 1 and the system of FIG. 2B in accordance with various aspects described herein.

FIG. 2D is a block diagram illustrating an example, non-limiting embodiment of the system functioning within the communications network of FIG. 1 and in conjunction with one or more sensors in accordance with various aspects described herein.

FIG. 2E is a block diagram illustrating an example, non-limiting embodiment of the system functioning within the communications network of FIG. 1 and in conjunction with one or more sensors in accordance with various aspects described herein.

FIG. 2F is a block diagram illustrating an example, non-limiting embodiment of the system functioning within the communications network of FIG. 1 and in conjunction with one or more sensors in accordance with various aspects described herein.

FIG. 2G is a block diagram illustrating an example, non-limiting embodiment of the system functioning within the communications network 125 of FIG. 1 and in conjunction with one or more sensors in accordance with various aspects described herein.

FIG. 2H is a block diagram illustrating an example, non-limiting embodiment of a system functioning within the communications network 125 of FIG. 1 in accordance with various aspects described herein.

FIG. 2I is a block diagram illustrating an example, non-limiting embodiment of a system functioning within the communication network of FIG. 1 in accordance with various aspects described herein.

FIG. 2J depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for collecting, for a user, information about consumption by the user of content at a user device and with other devices and persons in an environment. Based on the collected information, the user's preferences for content consumption and interaction may be determined and used when presenting subsequent user content to the user. In this way, the information presented to the user is uniquely tailored to the best experience for the user based on their content consumption preferences. Other embodiments are described in the subject disclosure.

One or more aspects of the subject disclosure include receiving data describing a consumption of first content data by a user at a user device, determining content style preferences of the user, wherein the determining the content style preferences for the user is based on the data describing the consumption of the first content data by the user, receiving second content data for the user, and modifying the second content data for the user, forming a modified content item, wherein the modifying the second content data is based on the content style preferences of the user.

One or more aspects of the subject disclosure include providing, over a communication network, a first content item to a user in an environment, receiving, from a plurality of sensors in the environment of the user, information about a consumption of the first content item by the user, based on the information about the consumption of the first content item by the user, determining content style preferences of the user, and receiving a second content item for the user. Aspects of the subject disclosure further include modifying the second content item for the user, forming a modified content item, wherein the modifying the second content item is based on the content style preferences of the user to improve attractiveness of the second content item to the user, and providing, over the communication network, the modified content item to the user.

One or more aspects of the subject disclosure include providing, over a communication network, a first content item to a user in an environment, receiving, from a plurality of sensors proximate the user, information about a consumption of the first content item by the user, storing, in a content consumption database, the information about the consumption of the first content item by the user, retrieving, from the content consumption database, the information about the consumption of the first content item by the user, and retrieving, from the content consumption database, additional content consumption information for the user, the additional content consumption information relating to other consumption of other content items by the user. Aspects of the subject disclosure further include determining content style preferences of the user, wherein the determining the content style preferences of the user is based on the information about the consumption of the first content item by the user and the additional content consumption information, receiving a second content item for communication to the user, modifying the second content item for the user, forming a modified content item, wherein the modifying the second content item is based on the content style preferences of the user to improve attractiveness of the second content item to the user, and providing, over the communication network, the modified content item to the user.

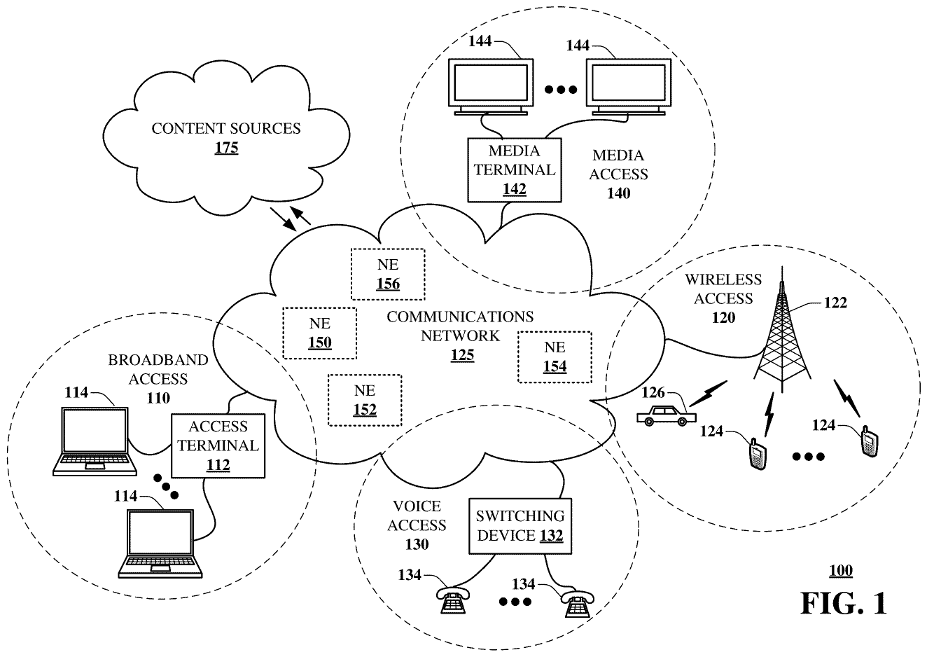

Referring now to FIG. 1, a block diagram is shown illustrating an example, non-limiting embodiment of a system 100 in accordance with various aspects described herein. For example, system 100 can facilitate in whole or in part collecting information about how a user consumes and interacts with content items including interpersonal interactions and using the collected information to select and modify future content items sent to the user to tailor the provided content to the user's preferences. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

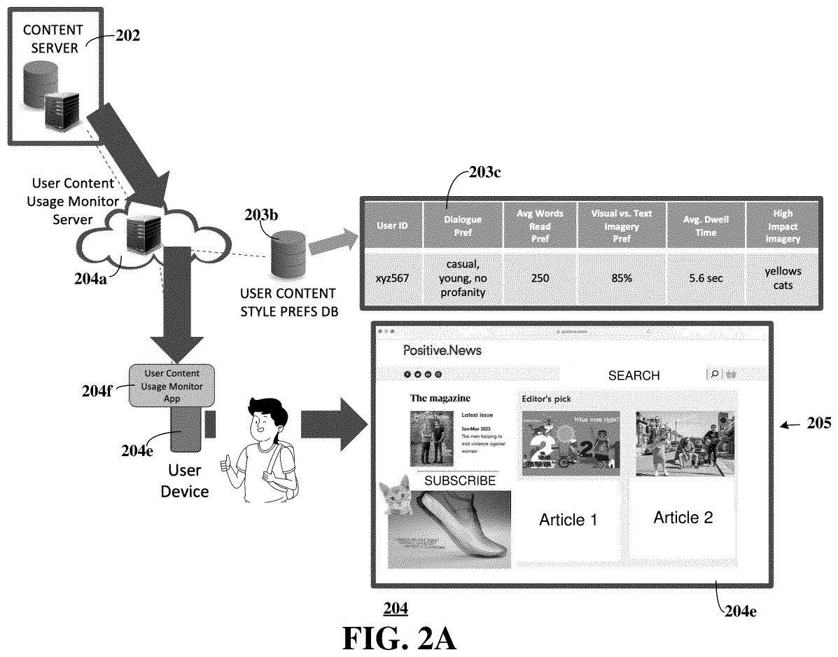

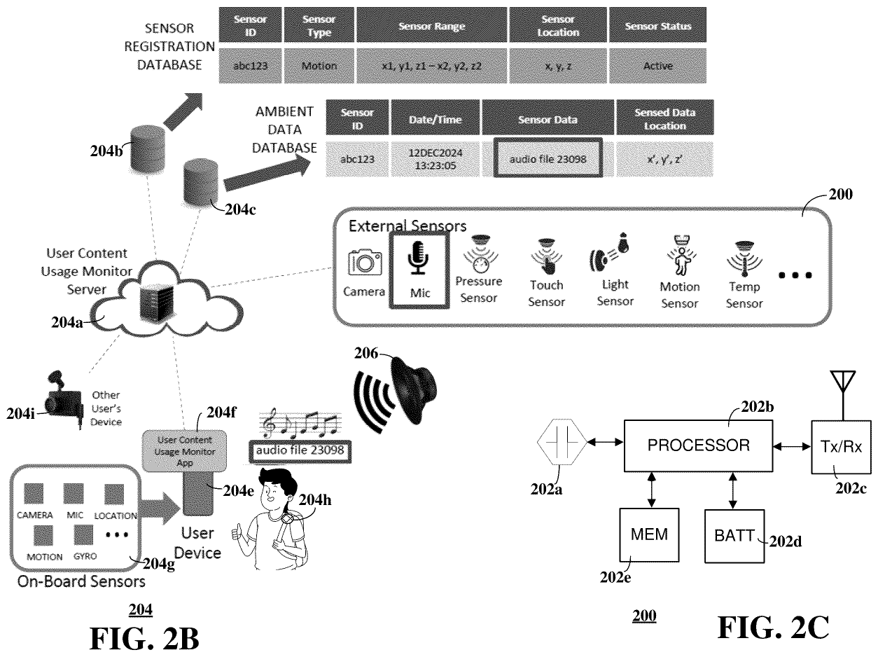

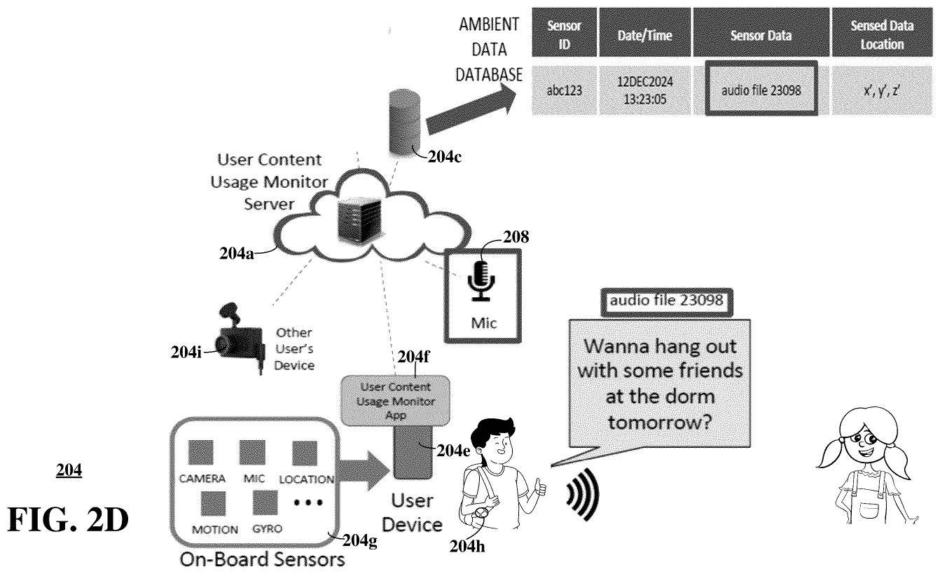

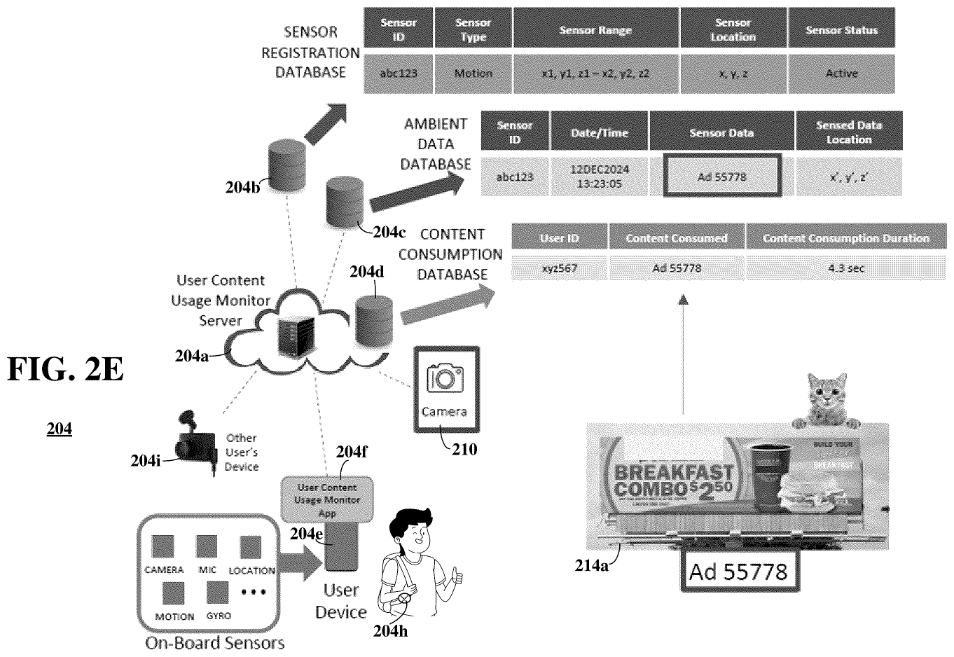

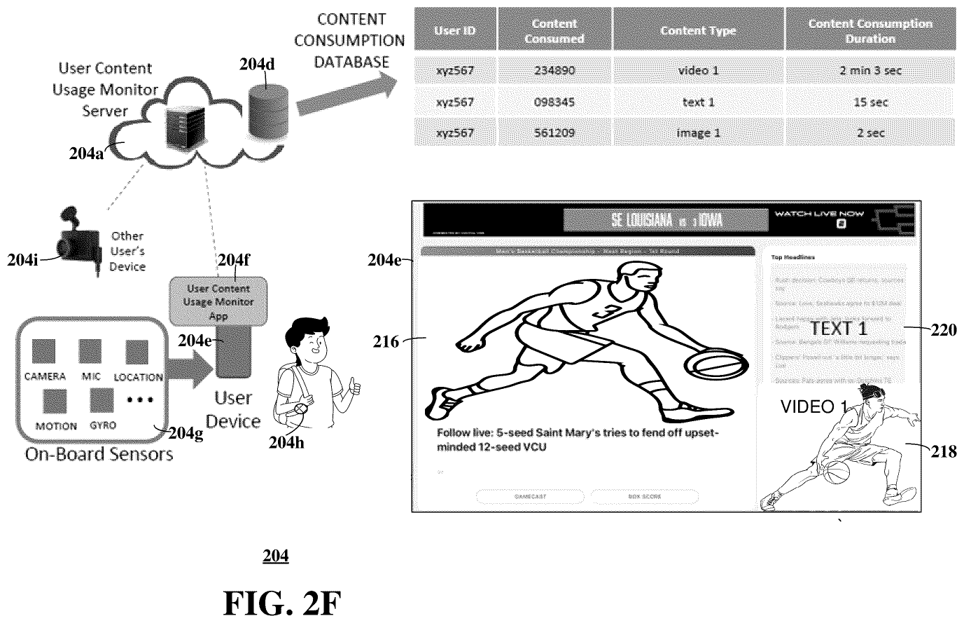

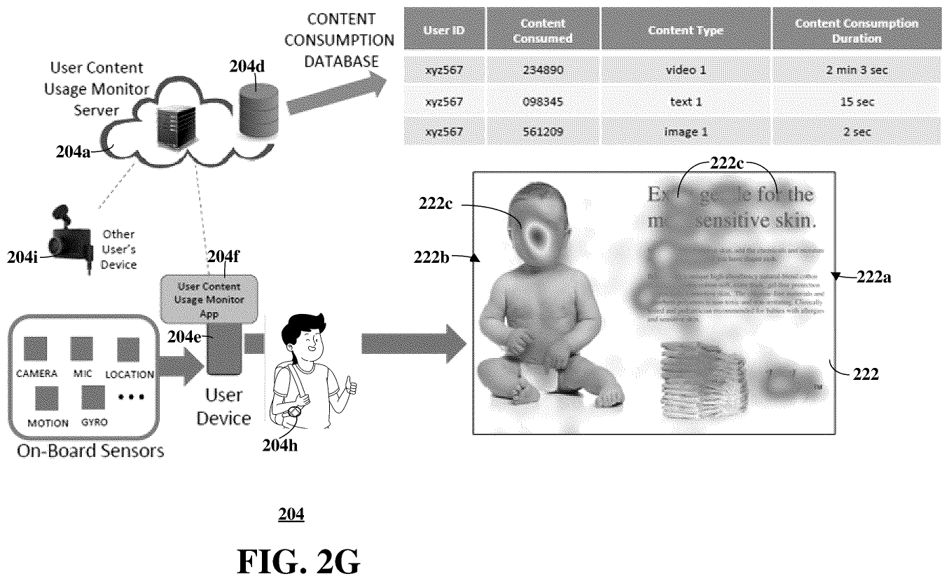

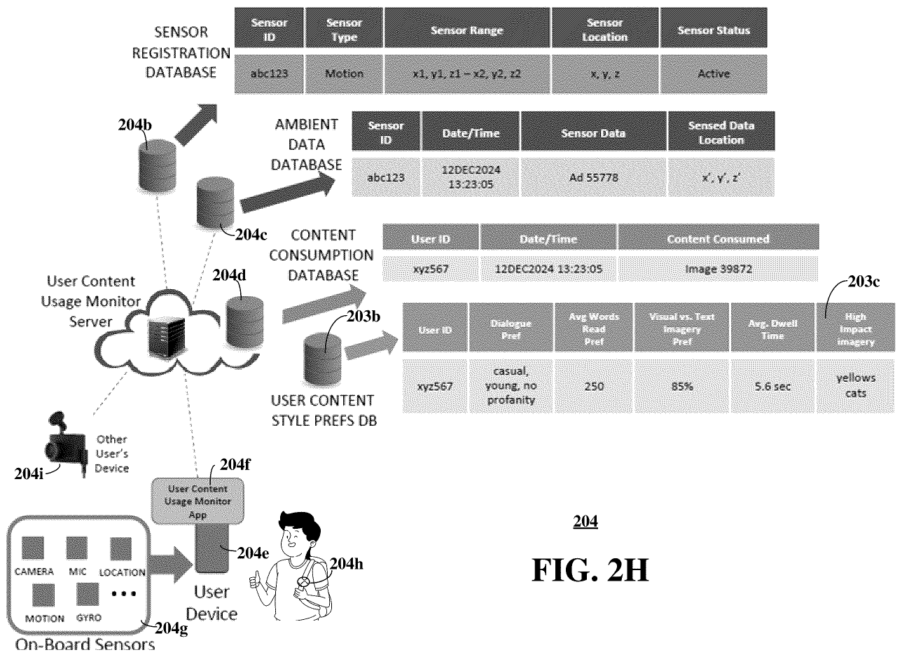

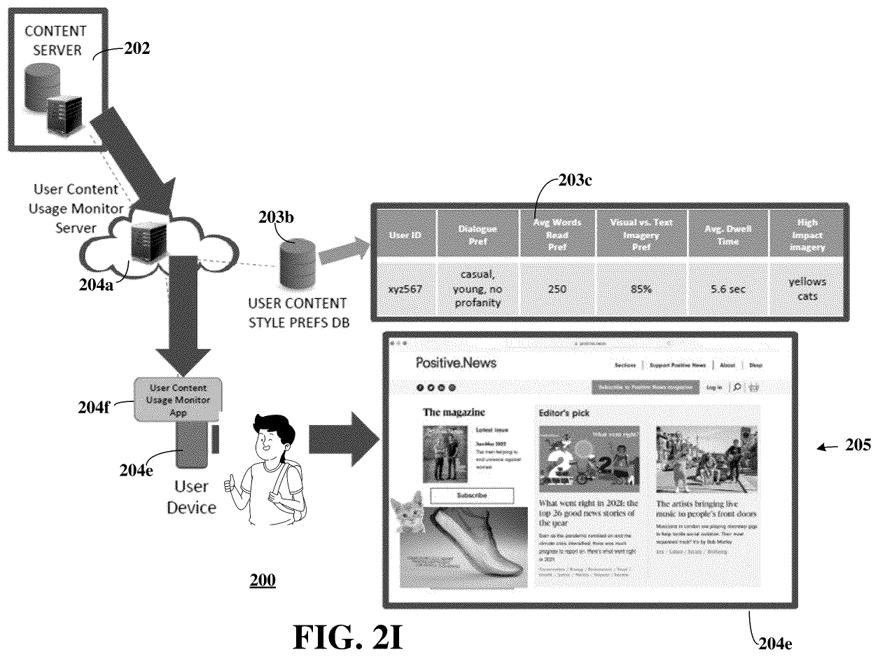

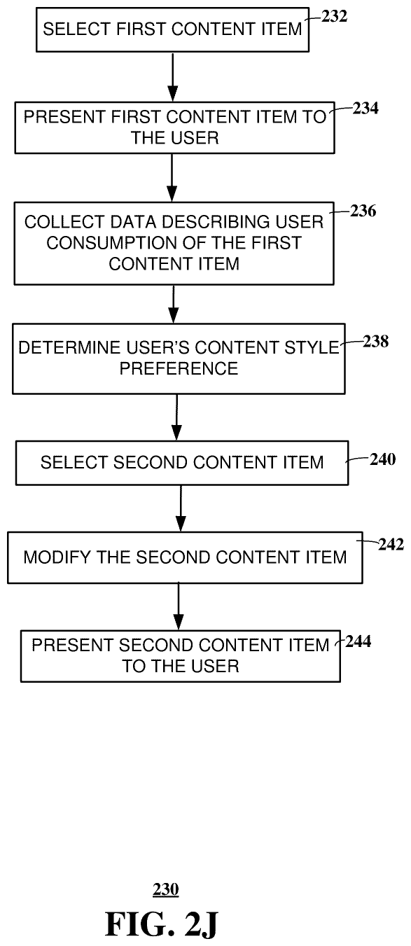

FIG. 2A is a block diagram illustrating an example, non-limiting embodiment of a system 204 functioning within the communication network of FIG. 1 in accordance with various aspects described herein. The system 204 includes in this example, a user content usage monitor server 204a, a user content style preferences database 203b storing records. The records relate to content items 205 provided to the user at user device 204e. In embodiments, the user may access, over the communications network 125, a content server 202 among the content sources 175. The user may access any type of content including web pages, audio files and video files, text including messaging communications, and others including streaming content. In the example, the content items requested by the user are provided to the user content usage monitor server 204a. In addition to requested content items, such as a streaming video file, the content server 202 or other source may provide content items not requested by the user, including for example advertisements to be displayed on the user device 204e. The advertisements and other secondary content may originate on the content server 202 or another network source such as an advertising server.

Generally, the user consumes content at user device 204e. The user device 204e may be any suitable device such as a smartphone or tablet computer or other wireless device. The user device 204e is location aware. Toward that end, the user device 204e may include a Global Positioning System (GPS) or other global navigation system radio receiver for determining the location of the user device 204e and, therefrom, the location of the user. Generally, the user device 204e may be a device such as a smartphone, tablet computer or other computer which is handheld or otherwise travels with the user. The user device 204e may include a user interface such as a display or touch sensitive display and a keypad, along with a microphone and a speaker for audio processing. The user device 204e may include one or more processing systems including a processor and memory for processing and storing data. The user device 204e includes functional features including user content usage monitor application 204f. The user content usage monitor application 204f may operate in conjunction with the user content usage monitor server 204a to detect and monitor the types of content experienced by the user and to modify content based on detected user preferences.

Over time, the user may consume a wide range of content types and a substantial amount of content. In the example of FIG. 2A, the user device 204e displays a magazine with content items, one or more news articles, and other possibilities. The content items are presented as items the user may select, such as by manipulating the touch screen display. The items selected by the user are related to the user's preferences of content items to see, content types, and content presentation.

Because the user may be viewing a large number and variety of content items, there is a need for presentation of content to the user in a style that best meets the preferences of the user. When electronic content is presented to a user, in whatever form it may take such as text, image, video, audio, and others, the presentation of the content does not consider the user's preferred style for consuming content.

In accordance with aspects described herein, the style preferences and other preferences of the user may be based on an analysis of the user's consumption of previous content and the style in which it was presented that best attracted the user's attention when offered on the user device 204e. The user and the application may use a network node such as a server that operates as the user content usage monitor server 204a. This function may be provided as a service or a paid service by a carrier provider, a network provider, or other connection provider or a partner of such a provider or network operator.

In an example, an operator of the communications network 125 may also operate the style preference analysis system and the user content usage monitor server 204a. The system and method may collect at the user content usage monitor server 204a information about content items received at the user content usage monitor server 204a and provided to the user device 204e. The information may be stored as one or more records in the user content style preferences database 203b. In the illustrated example, a record such as record may store user content preference data in fields such as a user identifier field, a dialog preference field, an average words read preference field, an imagery preference field, an average dwell time field and a high impact imagery field. Other data and other fields may be determined, processed and stored in other embodiments. The embodiment of FIG. 2A is intended to be exemplary only.

FIG. 2B is a block diagram illustrating an example, non-limiting embodiment of a system 204 functioning within the communications network 125 of FIG. 1 and in conjunction with one or more sensors such as sensor 200 of FIG. 2C in accordance with various aspects described herein. The system 204 may implement a method for collection of data that describes how a user communicates and how the user consumes content, preferably so as to be able to present subsequent content to the user using a style that is most preferred to the user and most likely will attract the user's attention to consume the subsequent content. In the example embodiment of FIG. 2B, the system 204 includes a server 204a, and a sensor registration database 204b, and a content consumption data database 204d. Further, in the example implementation of FIG. 2B, the system 204 includes a user device 204e associated with a user.

The system 204 interacts with one or more sensors such as sensor 200 which may be configured as illustrated in FIG. 2C. FIG. 2C is a block diagram illustrating an example, non-limiting embodiment of a sensor 200 functioning within the communications network 125 of FIG. 1 and the system 204 of FIG. 2B in accordance with various aspects described herein. The sensor 200 in the exemplary embodiment includes a sensor device 202a, a processor 202b, a memory 202e, and communication circuit 202c. The components of the sensor 200 may be powered by a battery 202d or other energy source. Components of the sensor 200 may be contained in a suitable housing which may, for example, provide weather resistance for outdoor applications. Other embodiments of sensor 200 may include other or additional elements for performing particular functions.

The sensor device 202a may be any device that collects information about an environment in which the sensor 200 is located. Examples of such a sensor device 202a include a camera which produces still images or video files or a video feed of a scene where the sensor 200 is located. The camera may include various types of cameras, such as image, video, infrared, thermal, and others and combinations of these. Another example of such a sensor device 202a is a microphone which is sensitive to audio in the vicinity of the sensor 200 and produces an analog signal or digital data representative of the sound.

Other examples of such sensor devices 200a measure or detect an ambient condition. One example of such a sensor device 202a is a pressure sensor which detects a pressure or force applied to the pressure sensor by another object or substance near the sensor 200 and produces an analog signal or digital data representative of the force. Another example of such a sensor device 202a is a touch sensor which detects a touch or contact, by a human or other, and produces an analog signal or digital data representative of the touch or contact. Another example of such a sensor device 202a is a light sensor that detects light or other ambient energy in the location of the sensor 200 and produces an analog signal or digital data representative of the light. Another example of such a sensor device 202a is a motion sensor which detects a motion applied to the sensor 200 and produces an analog signal or digital data representative of the motion. Another example of such a sensor device 202a is a temperature sensor which detects ambient temperature or another temperature in the vicinity of the sensor 200 and produces an analog signal or digital data representative of the temperatures. Any other type of sensor or combination of sensors may be included as the sensor device 202a.

The processor 202b may be part of a processing system which cooperates with data and instructions stored in the memory 202e to control operation of the sensor 200. The processor 202b may include one or more processors or microcontrollers or other data processing systems. The processor 202b may, for example, receive analog signals from the sensor device 202a and convert the analog signals to digital data. In other embodiments, the processor 202b may receive digital data from the sensor device 202a. The digital data may be stored in the memory 202e or be provided to the communication circuit 202c. Further, the processor 202b may control functions of the sensor device 202a such as by turning on and off the sensor device 202a and modulating controllable aspects of the sensor device such as a relative sensitivity of a light sensor or touch sensor.

Further, the sensor device 202a may be associated with further control functions that may be managed by the processor 202b. In an example, the sensor device 202a includes a video camera mounted on a motor-controlled fixture that may be actuated to direct the video camera toward a selected direction. The processor 202b may receive signals from a remote source, via the communication circuit 202c, and in turn, generate control signals to actuate one or more motors and direct the camera to the selected direction. The processor 202b, or the sensor 200, may be location aware. For example, the processor 202b may receive location information from another source, such as a Global Positioning System (GPS) receiver of the communication circuit 202c, and determine location of the sensor 200 based on the location information.

The communication circuit 202c includes any suitable circuitry for communication of data and other information between the sensor 200 and a remote source or destination. In one example, the communication circuit 202c includes a cellular radio which may operate in conjunction with equipment of wireless access 120 (FIG. 1) to provide information related to the output of the sensor device 202a to a remote location over a cellular network such as a fifth generation (5G) cellular network, sixth generation (6G) cellular network or other radio network. The communication circuit 202c may also include short-range wireless communications capabilities not requiring a network, such as Wi-Fi® or Bluetooth®. Bluetooth® is a registered trademark owned by the Bluetooth Special Interest Group. Wi-Fi® is a registered trademark of the Wi-Fi Alliance. As noted, the communication circuit 202c may include a GPS radio or other circuit for receiving position-finding data for use in determining a location of the sensor 200. In another example, the communication circuit 202c may provide wireline communication such as over an Ethernet® connection to a remote source or destination. Ethernet is a registered trademark of Xerox Corporation.

The information communicated by the communication circuit 202c may include uplink information based on information sensed by or collected by the sensor device 202a, such as data forming a video feed from a video camera. The information communicated by the communication circuit 202c may include downlink information provided to the sensor 200 to control some aspect of the sensor 200, such as motor control signals to control a motor which directs the view of the video camera to a scene of interest or actuation signals to turn on or turn off the sensor device 202a or to control some feature of the sensor device 202a.

The battery 202d provides operating power to the components of the sensor 200. The battery 202d may be a depletable, rechargeable energy storage element. In embodiments, the battery 202d may be replaced by or may supplement a hard-wired connection to electrical mains.

Sensors such as the sensor 200 may be located in a variety of areas for collecting sensed information. The sensed information may be made available to remote destinations for use by various users. Such users may be exposed to a variety of information in the user's ambient environment. Such information may come from conversations, media such as television and radio, electronic or online sources such news feeds to a smartphone or other handheld device, and other sources. Sensors in the vicinity of the user may detect the information in the user's ambient environment.

Data about the information describing a user's ambient environment may be collected by a network node for the purpose of analysis to determine or predict how a user communicates with a user device such as user device 204e and how the user prefers to consume content. User preferences may be predicted based on real world or electronically presented content to which the user is exposed. The user's preference prediction may be improved by detecting data confirming the user's consumption of the content. Such detection may be done in part by sensors such as the sensor 200 of FIG. 2A. Subsequent content presentation to the user may be modified based on the preference prediction.

Referring again to FIG. 2B, the system 204 further interacts with other sensors including sensors associated with the user device 204e. The user device 204e includes a number of on-board sensors 204g which may have any of the aspects of sensor 200. In the example, the on-board sensors 204g form function units of the user device 204 e for sensing one or more aspects of operation of the user device 204e. In the illustrated example, the on-board sensors 204g include a camera, a microphone, a location sensor such as a GPS circuit, a motion sensor and a gyroscope. Other embodiments may include other sensors and other types of sensors as well.

The on-board sensors 204g may include other types of sensors as well. In some embodiments, the on-board sensors 204g include wearable sensors 204h. In the illustrated example, wearable sensor 204h includes a camera associated with a backpack worn by the user. Other examples of wearable sensors 204h include a camera associated with the user's smart glasses and a wristwatch. Such wearable sensors 204h each may have a full complement of sensors including cameras, motion sensors, a microphone, a location sensor, a gyroscope, and others. These examples of the on-board sensors 204g and wearable sensors 204h are intended to be exemplary only.

The user device 204e is in radio communication with a remote network such as a cellular network. Example cellular networks include 5G, 6G and follow-on cellular mobility networks, Wi-Fi networks and other radio networks that provide two-way data communication for the user device 204e. In the example, the user device 204e includes a radio transceiver, a processing system including a processor and memory, and a user interface. The radio transceiver provides radio communication with the cellular network or other communication network. In other embodiments, the user device 204e may be, for example, a connected vehicle and include one or more radio transceivers adapted for communication. The user device 204e may access the radio transceivers of the vehicle and use other features of the connected vehicle such as an in-dash user interface.

The user interface of the user device 204e or the in-dash user interface may include, for example, a touch sensitive display or a keyboard. The display may be used for showing textual information such as news feeds, textual messages from other users, etc. The display may further be used for showing graphical information such as maps of a region. The display may further be used for showing images such as photos taken by a camera sensor or provided from a news source or other user, a video file of images or a live video feed from a camera associated with a news source, publisher or other user, for example. Views on the display may be controlled by touch-sensitive feature or an associated keyboard. The user interface may further include a speaker system for audio playback of audio received from another source or user. The user interface may further include a microphone for receiving spoken commands and other audible information.

Sensors including the on-board sensors 204g and the wearable sensors 204h may be in communication with the server 204a for implementing the ambient sensor system. The sensors may broadcast their availability to users under certain conditions and make themselves available to collect ambient data on behalf of a user. The sensors including the on-board sensors 204g and wearable sensors 204h may communicate with the server 204a in any suitable manner, including wirelessly and over a wireline network. The sensors may advertise their capabilities, their location and any other suitable information to the server 204a. Alternatively, the server 204a may poll the individual sensors in any suitable manner to collect necessary information from the sensors. The server 204a may in turn convey to a user and user device 204e information about sensor capabilities and other information.

Information from the sensors may be maintained in the sensor registration database 204b. The sensor registration database 204b may be in data communication with the server 204a over any suitable network connection. In embodiments, the information of the sensor registration database 204b may be stored and read under control of the server 204a.

FIG. 2B illustrates one example of the information that may be stored in the sensor registration database 204b for a particular sensor. A record of the sensor registration database 204b in this example includes a sensor identifier and sensor type information defining the type of the sensor, such as camera, microphone, temperature sensor, etc. A database record may further include sensor location information about the location of the sensor and range information for the sensor. The sensor location information may be determined by the sensor itself and be reported to the sensor registration database 204b, for example. The range information may define location coordinates within which the sensor is able to capture data. A record may further include a sensor status for the sensor and a network address for the sensor. For example, a status of active may indicate that the sensor is currently actively recording data; a status of inactive may indicate that the sensor is offline or not currently collecting data.

Any other suitable information about the sensor may be collected and stored at the sensor registration database 204b. For example, the sensor or the server 204a may provide and store in the database a description of the information available from the sensor and examples of the sensor information and its presentation. For example, if the sensor is a video sensor with a view of a particular location, the description field of the sensor record in the sensor registration database 204b may include a still photo of the view serving as a thumbnail photo. The still photo and other sensor description information may be provided to a user accessing the user content usage monitor application 204f.

Thus, the user may be equipped with a user device 204e such as a smart device that has speech recognition capabilities and is equipped with user content usage monitor application 204f. The user device 204e is also location aware. The user content usage monitor application 204f may be in communication with the user content usage monitor application server network node formed by or including the server 204a.

Further, the one or more types of sensors are within the proximity of the user's location at any given time. In addition, there may be one or more cameras and microphones that may also serve as sensors and may also be used to capture ambient data. The sensors may include on-board sensors 204g that are directly controlled by the user and exist on the user device 204e or other devices, such as wearable sensors 204h of a wearable device controlled by the user. The sensors may also include external sensors such as sensor 204i that may belong to other users or be publicly owned, such as a traffic camera. These external sensors, including cameras or microphones and others, are not directly managed or controlled by the user. Rather, they register their availability to be a part of the system 204 with the server 204a and the sensor registration database 204b. Each external sensor, including cameras and microphones, may also be location aware and may have network communication capabilities to register information describing their capabilities in the sensor registration database 204b. All sensors may continually perform or refresh their registrations on a periodic basis such that the active pool of available sensors to collect data describing a user's ambient environment at any given point in time is known to the system 204 including the server 204a. In addition, devices controlled by other users, such as a dashcam, may register as sensors. So, for example, another user's device such as sensor 204i may register in the sensor registration database 204b to collect data.

The ambient data database 204c may receive and store sensor data reported by the sensors. Active sensors may collect and report their sensor data describing ambient conditions within their sensor range on a continuous or semi-continuous basis, or according to any other schedule. In doing so, streams of sensor data from the sensors may be collected by the user content usage monitor server 204a and stored in the ambient data database 204c. Data collected by the user content usage monitor capture server 204a may include a sensor identifier, a date and timestamp, and location information for the sensed ambient data. Moreover, the sensor data stored in the ambient data database 204c may include audio data, image data, video data, or other data such as data describing the conditions detected by each sensor. Thus, sensors that are active are collecting and reporting data about ambient conditions, and continually updating. There is in effect a continual sensing and recording of user content usage data around each sensor, for future use, by the server 204a in the ambient data database 204c.

In some examples, then, a sensor of the user device 204e, a wearable sensor 204h, or other sensor closely associated with the user is used to track content consumption. This may provide information about how the user consumes information and the device used for such consumption. The sensors may include or employ, for example, a device for tracking eyeball position to locate the user's gaze on a display or other content source, including signs and video displays near the user, to learn what attracts the user's attention. Gaze information may include the time duration during which the user's gaze stays in a particular location. Gaze information may tell if the user looks at pictures and not text in content items, or if the user likes to read bulleted items rather than paragraphs of text. The sensors may include a microphone or other audio sensor to detect what the user is listening to on the user device 204e or another device or what the user is saying. Any necessary permission required to monitor the user, collect, store and process user information, should be obtained.

In the example of FIG. 2B, a speaker 206 is providing audio in the ambient environment of the user and the user device 204e. The user device 204e includes a microphone which is registered with the sensor registration database 204b. In the example, the microphone is registered with sensor identifier data of abc123. The microphone detects the audio, such as music, played or received at the user device 204e. Under control of the user content usage monitor application 204f, the user device 204e conveys information about the detected audio to the user content usage monitor server 204a. The user content usage monitor server 204a in turn stores information about the detected audio in the ambient data database 204c. In the example, the information stored in a record of the database includes the sensor identifier of the microphone that detected and reported the audio, or abc123; a date and time stamp; the detected sensor data; and a sensor data location. In the example, the sensor data is defined as audio file 23098, both at the user device 204e and in the ambient data database. Any suitable sensor data may be collected. In the example of an audio file, the sound detected at the microphone may be converted to a digital format just as an MP3 or AAC file. The sound file may then be transmitted from the user device 204e to the user content usage monitor server 204a for storage in the sensor registration database 204b as sensor data.

Accordingly, the database record entered in the ambient data database 204c becomes a record that the user has heard the particular audio recording designated audio file 23098, on the designated date, time and location. The same microphone sensor may be used for all types of ambient audio collection by the user since the user device 204e is generally maintained near the user during much of the user's active time. Thus, the microphone may monitor the user when the user is having a personal conversation with another person, either face to face, on the telephone or over a video connection, or in another environment. In general, permission is always obtained from the user and any other participants in such a conversation to ensure compliance with all relevant privacy regulations.

FIG. 2D is a block diagram illustrating an example, non-limiting embodiment of the system 204 functioning within the communications network 125 of FIG. 1 and in conjunction with one or more sensors such as sensor 200 of FIG. 2C in accordance with various aspects described herein. FIG. 2D represents a further or additional example of the user conversing in a face-to-face communication with another person, and the conversation being detected and monitored by the system 204. The conversation may be detected and monitored by a microphone sensor in the vicinity of the user, such as a microphone of the user device 204e or a microphone of wearable sensor 204h, or a microphone 208 located in the ambient environment. In the example, the user is inviting a second party to get together at a future time. The second party appears to be a classmate.

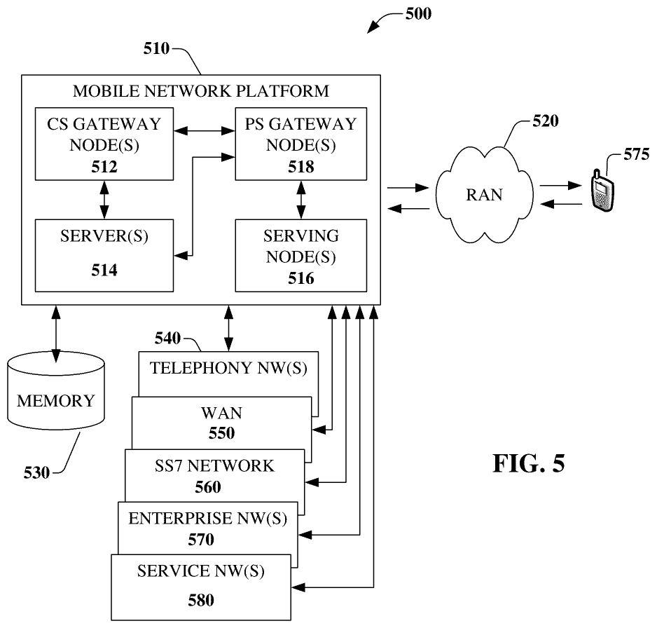

Thus, in a manner similar to the occurrence pictured in FIG. 5B, a microphone in the environment or on board the user device 204e may detect audio such as spoken dialogue by the user in a real-life conversation. This audio may be detected and processed by the user content usage monitor application 204f on the user device 204e.

This audio may further be saved in the ambient data database 204c as ambient data and may be analyzed subsequently by the user content usage monitor serve 204a to define communication content preferences that are inferred for the user. For example, the user's method of communication in terms of dialogue and vernacular may be inferred, based on content saved in the audio file. In an example, an analysis of the illustrated statement by the user, “Wanna hang out with some friends at the dorm tomorrow,” may be used to help create a dialogue preference such as “casual, young, no profanity.” These inferences improve over time as more and more data is available and analyzed.

Thus, the saved audio files in the ambient data database 204c serve as data point examples of how the user communicates. More specifically, if the audio file includes a conversation, it becomes an example of how the user communicates with the particular other party to the conversation. In this manner, the system 204 builds up a set of knowledge regarding how the user communicates with other particular people and other types of people. In some embodiments, the ambient data database 204c may store information identifying the other participants in the conversation, as well as information about the relationship between the user and the participant. Relationship information in some examples includes “boss,” “coworker,” “classmate,” “friend,” “sibling,” “parent,” “child,” etc. Such categorization may help the system understand and use the awareness of how the user communicates with other parties to a conversation.

FIG. 2E is a block diagram illustrating an example, non-limiting embodiment of the system 204 functioning within the communications network 125 of FIG. 1 and in conjunction with one or more sensors such as sensor 200 of FIG. 2C in accordance with various aspects described herein. FIG. 2E represents a further or additional example of the user experiencing a content item and detection of that experience by the system 204 and storage of information about the experience.

FIG. 2E depicts an illustrative embodiment of a user interaction that may be monitored by the system 204 of FIG. 2B. The user interaction is shown in association with the user device 204e as held or worn by the user. Further in the example embodiment, the user may be equipped with a wearable sensor 204h such as a camera, microphone or combination of these associated with the eyeglasses worn by the user.

The system 204 of the embodiment of FIG. 2E includes content consumption database 204d, generally as described and exemplified herein in connection with FIG. 2B and FIG. 2D. In addition, the system 204 of the illustrated exemplary embodiment further includes a content consumption database 204d. The content consumption database 204d may operate, for example, under control of the user content usage monitor server, server 204a.

The content consumption database 204d may be accessed by the server 204a to store and retrieve information about content the user has been exposed to, such as on the user device 204e. In example, embodiments, the user may also be equipped with one or more devices such as the user device 204e or a wearable with a wearable sensor 204h that can detect and collect data describing how the user experiences their environment. That is, not only can the user device 204e or another device detect and collect data describing the user's environment, but it can also more specifically collect data describing “content” within the environment that the user experiences. This content can include electronically presented content such as content presented on the user device 204e or another external device.

In an example, a camera on the user device 204e may track the user's gaze as the user's eyes consume content on the device screen. The user content usage monitor application 204f on the user device 204e may associate the content presented on the coordinates of the display at the time the user's gaze is there and the ambient data capture server 204a may store information about the content presented to the user in the content consumption database 204d. The content consumption database 204d may, for example, store a record of the user's consumption of the content, as shown. Any suitable information may be stored in the record of the user's consumption in the database. In the example, each record in the content consumption database 204d includes sensor identification information, a data and timestamp, and information about the content consumed. The information about the content consumed may include a brief description, such as “image,” “text,” or “ad” for an advertisement. Further, information about the content consumed may include any other suitable identifier such as an identifying number. The visual content may be any type of content such as text, image, video, etc., presented by any type of application on the user device 204e or detected by another sensor such as a wearable sensor. In other examples, content may be recorded from transactional activity that the user is involved in but have indirect informational content. For example, the purchase of a meal, which implies knowledge of the nutritional content, or the completion of a tax form or an online word game, which implies knowledge of the subject matter but not explicit facts within those content forms. In yet more examples, the presence or absence of user action when correlated to a transactional sensor (e.g. the receipt of an opt-in notice but taking no action afterwards) may also be recorded as a content consumption entry.

Thus, the content consumption database 204d stores information about the user. The stored information includes data about what content is consumed, how the content is consumed and when the content is consumed by the user. Further, the stored data allows inferences and predictions about future user content consumption. In some example embodiments, the server 204a or other network node may include an artificial intelligence or machine learning (AI/ML) module to predict user content consumption. This may include predicting the types and amounts of content consumed, as well as any other information.

In the example of FIG. 2E, the system 204 may also detect and record the user's active consumption of content, whether it is real world content, or electronically presented content on the user device 204e. In this exemplary embodiment, an external camera sensor 210 may capture an image of the user at a location. The user content usage monitor of server 204a may analyze the known location of the user along with an estimated line-of-sight of the user based on the location of the user and the facial orientation and eye orientation of the user. This estimated line-of-sight from the user's location may be used to compare with known objects to be within the line-of-sight that are stored in a database of location-stamped images. The user device 204e or the wearable sensor 204h may include a camera that mimics the user's line-of-sight, such as a dashcam or a wearable. Depending on the user's context (current activity, location, etc), typical reactions based on visual data in their line-of-sight, and the personalization level of the message (is it a billboard to hundreds or a custom coupon for the user), the system may record the consumption in 204d as complete, partial, or ignored. Examples of wearable sensors may include a head-mounted camera or camera equipped eyewear. Based on user location and line of sight, the system 204 may predict that the advertiser will see the advertisement 214a.

In the example of FIG. 2E, the user is exposed to a publicly displayed advertisement 214a for a meal at a restaurant. Thus, visual images that the user consumes in real life may be captured and stored as consumed content. This may include anything that the user sees in this manner that may be detected and captured by an on-board sensor of the user device 204e, an external sensor such as a wearable sensor 204h or external camera sensor 210. The user content usage monitor server, server 204a may receive the sensor data over a network such as a cellular network and store the sensor data in the ambient data consumption database 204c as illustrated.

In the example, the camera sensor captures what the user sees, including the advertisement 214a. Any suitable data or information may be captured by the camera sensors and conveyed to the server 204a and stored in the content consumption database 204d. The user may control and set preferences for the system 204. Thus, in the future, the system 204 will respond to the user preferences when displaying such advertisements. For example, if the user is later viewing a social media feed on the user device 204e or another user device, the system 204 may operate to block the presentation of the advertisement 214a based on user preferences.

In another example, in accordance with the illustrated embodiment of FIG. 2E, the user content usage monitor server, server 204a, may predict that the advertisement caught the user's eye. And therefore, the content may be inferred to be consumed by the user and recorded as such in the content consumption database 204d. Other data, such as the inferred duration of the content consumption may also be recorded in the content consumption database 204d.

Moreover, the system 204 including the user content usage monitor server, server 204a, may determine sub-elements of a particular content item. This may be done, for example, through analysis by the user content usage monitor server, server 204a, particularly in the case where the content consumed had a higher-than-average content consumption duration for the user. So, in this case, it may be determined that a particular color such as yellow of the imagery of the advertisement 214a, and the cat in the imagery of the advertisement 214a, were sub-elements of the image that the user dwelled on longer than average.

In examples such as this, any statistical processing of the user's consumption of the content may be used. One example is maintaining an average duration of the user's consumption time, as well as deriving a preferred color or range of colors or other factors. In some example embodiments, the server 204a or other network node may include an artificial intelligence or machine learning (AI/ML) module to predict user content consumption. This may include predicting the types and amounts of content consumed, as well as any other information. In an example, an AI/ML module operating either on the user device 204e or on the server 204a may prepare a summary description of what it sees or hears of the content item and save the summary description in the ambient data consumption database 204c. In another example, the AI/ML module may include a speech to text tool which prepares a transcription for storage in the ambient data consumption database 204c. The content item, the summary description, or both may be saved with a suitable identifier of descriptor. The AI/ML module may further develop a predicted response of the user when a new content item is acquired by the user. This may be extended to all types of content items including audio, video, text and others, including personal interactions by the user.

Thus, in some embodiments, the user content usage monitor application 204f may also collect data describing the user's interactions with the user device 204e when the user consumes content on the user device 204e. For example, the data collected may include data describing how the user views visual content (such as by eye tracking using a camera on the user device 2043), what content the user spends more time displaying or actively viewing, what content the user interacts with, for example via touch or spoken inputs, and other user interactions with content presented.

FIG. 2F is a block diagram illustrating an example, non-limiting embodiment of the system 204 functioning within the communications network 125 of FIG. 1 and in conjunction with one or more sensors such as sensor 200 of FIG. 2C in accordance with various aspects described herein. FIG. 2F represents a further or additional example of the user experiencing one or more content items and detection of that experience by the system 204 and storage of information about the experience.

FIG. 2F depicts an illustrative embodiment of a user interaction that may be monitored by the system 204. The user interaction is shown in association with the user device 204e as held or worn by the user. Further in the example embodiment, the user may be equipped with a wearable sensor 204h such as a camera, microphone or combination of these associated with the eyeglasses worn by the user.

The user device 204e and the user content usage monitor application 204f may use methods such as eye tracking to record content consumed by the user. In embodiments, then, a content consumption record may be made for each type of content consumed by the user. This may include sub-content elements, as shown in the example. in FIG. 2F. The user device 204e displays multiple content items including a news content item 216, a video content item 218 and a text content item 220. Each respective content item may be detected and processed, for example, by the user content usage monitor application 204f. The user content usage monitor application 204f may determine or assign a content identifier and a content type such as video, text of image. Further, the user content usage monitor application 204f may determine or measure a content consumption duration during which the user viewed the news content item 216, watched the video content item 218, and viewed the text content item 220. The data and other information for the respective content items may be conveyed to the user content usage monitor server 204a and stored in the content consumption database 204d.

By recording each sub-element consumed by the user, insights may be derived by the system 204 including the user content usage monitor server, server 204a, such as not only how long the user consumes each type of content according to content type, but how frequently the user selects each type of content for consumption. This information and insight, over time, develops a characteristic profile for the user's preferences when the user is viewing content. The system 204 can determine what, stylistically, the user is interested in by way of content. This applies to all types of content, including what content is viewed by the user on the user device 204e or in the ambient environment (such as the advertisement 214a in FIG. 2E). This also applies to content that is consumed as audio. Such audio content may include the audio portion of an advertisement or other visual content item. Such audio content may include an audio soundtrack or music or person's voice, or particular sounds. In an example, the system 204 may may determine, based on user interaction with content, that the user is favorably inclined to hear sounds including a cat purring and a baby breathing while sleeping. At the same time, the system 204 may determine, based on user interaction with content items, that the user has a very strong negative reaction to the sound of a baby crying or the sound of a leaf blower. Each individual has a respective spectrum of frequencies that they hear well and sounds within a user's positive-experience spectrum may be preferred by the user. Such information about the user may be used when subsequently selecting content items, or formatting content items, to attract the user's attention and prompt further content consumption by the user.

FIG. 2G is a block diagram illustrating an example, non-limiting embodiment of the system 204 functioning within the communications network 125 of FIG. 1 and in conjunction with one or more sensors such as sensor 200 of FIG. 2C in accordance with various aspects described herein. FIG. 2G represents a further or additional example of the user experiencing one or more content items and detection of that experience by the system 204 and storage of information about the experience.

FIG. 2G depicts an illustrative embodiment of a user interaction that may be monitored by the system 204. The user interaction is shown in association with the user device 204e as held or worn by the user. Further in the example embodiment, the user may be equipped with a wearable sensor 204h such as a camera, microphone or combination of these associated with the eyeglasses worn by the user.

In FIG. 2G, the user views a content item 222 that includes sub-elements. The sub-elements in this example include text 222a and an image 222b of a baby. A heat map 222c has been developed showing areas of greater interest by the user and lesser interest by the user. The heat map is based on factors including the time duration during which the user gazes at a particular region of the content item 222. The heat map 222c includes intensely colored areas, such as the face of the baby in the image 222b, where the user's gaze lingered longer, and lighter colored areas, such as portions of the text 222a, where the user's gaze lasted a shorter duration.

Thus, in some embodiments, the content item 222 viewed on the user device 204e may be analyzed using heat maps such as the heat map 222c to indicate relatively how long the user's gaze focused on each sub element of the content item 222. The sub-elements of the content item 222 may be assigned areas on the display such that it may be determined what types of content and what characteristics of content are attracting the user's attention relatively more.

The user content usage monitor server, server 204a, may analyze images consumed by the user such as the content item 222 to determine characteristics of the image that are appealing and attract the user's attention. Much like advertisement 214a including a yellow billboard with a cat in FIG. 2E, in the example of FIG. 2G, it may be that the user is attracted to topical images related to raising children. The analysis of the user's interaction with the image, such as monitoring the user's gaze and developing the heat map 222c, enables the system 204 to identify such user preferences.

In embodiments, this method or similar procedure may also be used to estimate how much textual content the user is willing to read. For example, the heat map 222c indicates portions of the text 222a the user focused on for relatively longer or shorter durations. This may provide insights as to the user's preference of length of textual content. In other examples, the analysis and conclusions about the user's preference for text items may be aggregated across different types of text that vary based on style, text font and size, word choice and content of the text item, use of adjacent graphics or video, and other aspects as well. This may result in a more complete and more granular understanding of the user's preferences. Such an understanding may then be used for selecting and modifying content items to send to the user that will be most appealing to the user.

FIG. 2H is a block diagram illustrating an example, non-limiting embodiment of a system 204 functioning within the communications network 125 of FIG. 1 and in conjunction with one or more sensors such as sensor 200 of FIG. 2C in accordance with various aspects described herein. The system 204 of FIG. 2H may implement a method for collection of data that describes how a user communicates and how the user consumes content, preferably so as to be able to present subsequent content to the user using a style that is most preferred to the user and most likely will attract the user's attention to consume the subsequent content. In the example embodiment of FIG. 2H, the system 204 includes server 204a operating as a user content usage monitor server, sensor registration database 204b, ambient data database 204c and content consumption database 204d. Further, in the example implementation of FIG. 2B, the system 204 includes a user device 204e associated with a user. The user device 204e implements or is controlled by operation of a user content usage monitor application 204f. The user content usage monitor application 204f cooperates with the user content usage monitor server of server 204a.

The embodiment of the system 204 in FIG. 2H further includes a user content style preferences database 203b storing records. The records relate to user preferences determined based on content items provided to the user, such as at user device 204e, and based on the user's response to such content items. In the illustrated example, the record includes several fields including user identification information and preference information for a type of dialog the user prefers with other persons. In the example, the dialog type is described as “casual, young and with no profanity.” The example record further includes fields for an average number of words read by the user when presented with text content items and a visual versus text imagery preference for the user. The example record further includes fields describing an average dwell time on a content item. Dwell time refers to the amount of time a user spends viewing an advertisement or other content item. A longer dwell time generally indicates a more engaging and relevant content item. The example record further includes a field describing information about imagery that has been determined to generate a high impact with this user. In the example, for the user associated with the record, imagery using yellow colors and cats has been determined to generate a high impact. In other embodiments, low impact imager may be identified as well, such as for a user who has been determined to have an aversion to cats and children.

The information in the user content style preferences database 203b may be developed and modified over time. For example, as new content items are provided to the user over any source, including the user device 204e as well as information collected by sensors in the user's vicinity, the understanding of the user's preferences when consuming content items may be developed, modified and improved. As the user's content consumption database record is populated and adjusted over time, a user content style preference database entry may be generated by the user content usage monitor server, server 204a, for each user. This profile of the user is a representation of the inferred preferences of the user as to how the user prefers to consume content based on the analysis of their past content consumption activities.

As illustrated in FIG. 2H, the user content style preferences profile for the user may include preferred content style characteristics, such as the preferred dialogue, or vernacular that the user typically communicates with, a record of the average words read by the user per content consumption, a preference of the user as to how much they prefer visual versus text content, how often or how long the user typically dwells on an item of content, and data representing the types of imagery that typically captures the user's attention. The preference data may relate to audio preferences, such as preferred sounds or tones determined for the user. Other characteristics of style preferences may be stored as well. This includes determining negative preferences of the user, or aversions. Such aversions are aspects of a content item that create a negative response for the user, and which may be selected as features of content items to avoid in the future.

Moreover, for a given user, there may be more than one entry in the user content style preferences database 203b. This may be, for example, to store, preferences for various types of content consumed by the user. For example, an entry or record may exist in the user content style preferences database 203b for webpage consumption preferences and another entry may exist in the user content style preferences database 203b for social media consumption preferences. Other types of media consumption may be included as well, including other types of communications that are sent to a user. Examples include content items delivered as email, text, video, messages, and others.

FIG. 2I is a block diagram illustrating an example, non-limiting embodiment of system 204 functioning within the communications network 125 of FIG. 1 in accordance with various aspects described herein. The system 204 includes in this example user content usage monitor server 204a, user content style preferences database 203b storing records. The records relate to content items 205 provided to the user at user device 204e. In embodiments, the user may access, over the communications network 125 (FIG. 1), a content server 202 among the content sources 175. The user may access any type of content including web pages, audio files and video files, text including messaging communications, and others including streaming content. In the example, the content items requested by the user are provided to the user content usage monitor server 204a. In addition to requested content items, such as a streaming video file, the content server 202 or other source may provide content items not requested by the user, including for example advertisements to be displayed on the user device 204e. The advertisements and other secondary content may originate on the content server 202 or another network source such as an advertising server.

Generally, the user consumes content at user device 204e. The user device 204e may be any suitable device such as a smartphone or tablet computer or other wireless device. Over time, the user may consume a wide range of content types and a substantial amount of content. In the example of FIG. 2I, the user device 204e displays a magazine with content items, one or more news articles, and other possibilities. The content items are presented as items the user may select, such as by manipulating the touch screen display of the user device 204e. The items selected by the user are related to the user's preferences of content items to see, content types, and content presentation.

Once a user's content styles preference profile is established in the user content style preferences database 203b, the user content usage monitor server, server 204a, may use this data to modify content from other content servers such as content server 202, that are sending content to the user at a known ID address for a user device such as user device 204e. In the example shown, for instance, a webpage is sent from the content server to the user device and the user ID is used to identify the content style preferences of the user. Using the information in the user content style preferences database 203b, the content may be adjusted to use the style preferences before it is presented to the user. Therefore, the content presented to the user is uniquely tailored to the best experience for the user based on their content consumption preferences.

The content presented to the user may be selected in any suitable manner, including by an AI/ML module which uses information stored in the user content style preferences database 203b to select content items likely to be of interest to the user. Further, the features of the content items which may be sensed by the person consuming the content item, such as appearance, sound, etc., may be selected and tailored to the consumer, again based on information in the user content style preferences database 203b. Another user may see the same content items, such as a particular news story or advertisement, but the other user may see and hear it very differently, such as with a different color scheme, presented in a different voice, a different accent or a different language. Yet another user may see completely different content items. Presentation to each user is tailored to what is known about the user.

As a result of this tailoring of content to the user's preferences, the likelihood of increasing the user's affinity for a content item is increased. The user's style preferences, analyzed and stored in the user content style preferences database 203b, are based on previous consumption of content items, including information about the style in which the content was presented and best attracted the user attention, or produced a negative affinity. Since any given content item subsequently delivered to the user is tailored to the user, the likelihood is increased that the user will engage more deeply and longer with the content. As a result, advertising content items will likely be more effective for the advertiser as well as for the user, and non-advertising content items will be more appealing and better directed to the user's interests.

The ideas and techniques and technology presented here by way of example may be extended in many ways. In one example, rather than using a smartphone or tablet or similar device as the user device 204e, the user device 204e may be embodied as other devices. In one example, the user device 204e includes apparatus for presenting a virtual reality (VR), extended reality (XR) or augmented reality (AR) (collectively, AR) environment to the user. Such an environment may interact with a user's vision, hearing, other senses, as well as a sense of time of the user. The AR system may select and modify and warp some aspects of the environment based on information such as the content of the user content style preferences database 203b. For example, the user may have a strong aversion to heights and feelings of physical insecurity or instability. Based on awareness of that aversion, the AR system may selectively avoid presenting such experiences to the user.

Any other tailoring of an AR experience to the user, based on the user's preferences, may be done. This includes expressed preferences of the user as well as preferences determined automatically by the system 204 based on the user's ongoing reaction to information and its presentation to the user. In an example, the system 204 may automatically, selectively vary presentation of content to the user to gauge the user's response to the different content items and presentation. For example, in a first AR environment, the system may implement a gaming experience in which the user battles a monster colored red. In a second environment, the system may implement the same or similar experience in which the monster is black or patterned in different colors. The system may perform a type of AB testing to draw out the user's preferences and proactively fill out information in the user content style preferences database 20b.

In a further example, the user device 204e may be embodied as headphones or earbuds which play or stream content to the user as the user wears the device. The user may interact with the headphones in some way or the system 204 may simply detect the user's nonverbal responses to the provided content, such as a sped-up gait or pace for walking due to tension or excitement in response to a content item, or a reduced heartrate or breathing rate due to relaxation created by soothing content. Further, relying on the location awareness of the user device, the system 204 may select a particular song or other content item that is appropriate for the user at a current location.

In another example, the user device 204e may be embodied as a sleep monitor device that detects aspects of the user's sleep patterns and provides suitable content to the user based thereon. For example, a bedside device that detects rapid eye movement (REM) sleep may be provided by the system with content items that may provoke a soothing response, or may be used for educational purposes, such as language instruction, while the user sleeps. When the user transitions out of REM sleep to another sleep phase, a different type of content may be automatically provided.

FIG. 2J depicts an illustrative embodiment of a method 230 in accordance with various aspects described herein. The method 230 may be performed at any suitable location such as a network node in a communication network or a data processing network. In an example, the method 230 may be performed at a network node including a data processing system having a processor and memory and responsive to instructions to implement the method 230. In some embodiments, the method 230 may be implemented by an ambient data capture server in data communication with a plurality of ambient environmental sensors. The method 230 may be performed at a device which is configured to receive data from a plurality of sensors such as sensor 200 over a communication network and to provide content items to a user associated with a user device. The method 230 may be initiated in response to any suitable input, including activation by a user requesting access to a content item or by a system to begin collecting sensor information from sensors in data communication with the network.

At step 232, a first content item may be selected to provide to a user. In exemplary embodiments, the user is accessible over a communication network and operates a user device, such as a smartphone or tablet computer. The content item includes information to be presented to the user, such as a news article, a video file, streaming video, an audio file or streaming audio, an e-mail message or other type of information to be presented to the user for review. In some embodiments, the first content is selected based on the user's content style preferences already determined.

At step 234, the first content item is presented to the user. In embodiments, the content item, such as a web page including multiple articles of information, may be transmitted over the communication network to the user device for display to the user on the user device. In general, the content item is formatted and styled to be appealing to the user and others who may view the content. Without further information, a generic type of formatting or style may be used, wherein the generic formatting is used for general users about whom little is known with respect to content preferences.

At step 236, data about the user's consumption of the first contact content item is collected. Such collected data may include information about the types of media the user consumes, such as the user selecting video media or content first before text media is selected, or selecting an audio file to listen to while driving a vehicle, for example. Such collected data may further include information about the amount of time the user spent viewing a particular content item, such as by tracking the user's gaze on a display device showing a transmitted web page to the user and monitoring an amount of time during which the user viewed the web page.

At step 236, any suitable, or available, information may be collected for further processing and analysis. In embodiments, a wide range of sensors are available to collect the data describing the user consumption of the content item. Such sensors may include onboard sensors contained in or associated with the user device, wearable sensors that that may be attached to the user, and environmental sensors that may be in the vicinity of the user, such as cameras and microphones adapted to collect information about the user and activities of the user and persons around the user.

At step 238, the method 230 includes determining the user's content style preferences. Such preferences include information about a manner and style and format of presentation of information on a user device or other device; information about consumption of such information, either the type of media consumed or time and location of consumption; or any other suitable information. Such preferences may further include any information about prioritizations or preferences of the user, such as an affinity for a particular color in media that is consumed or items displayed or sounds presented in the media consumed, such as a cat or child, or birdsong.

At step 240, a second content item for presentation to the user is selected. In some embodiments, the user content style preferences determined at step 238 may be used to select the second content item. Otherwise, the second content item may be selected on any suitable basis, such as selecting an item to be included as an advertisement provided on a web page to the user.

At step 242, the second content item is modified according to the user's content style preference, as determined at step 238. In examples, the color scheme used in the content item may be adjusted to match learned preferences of the user; imagery, such as a smiling cat, as has been learned to be appealing to a user, may be included in the second content item; and audio sounds or tones which have been learned to be appealing to the user may be attached to the content item as well.

At step 244, the second content item is presented to the user. In typical embodiments, the second content item may be conveyed over a communication network to a user device of the user for display and presentation on the user device.

In embodiments, the method 230 may be continually repeated, collecting more and more information about how a user interacts with content items and responds to content items. The collected information may be used to select and modify further content items. The result may be an ongoing process of increasingly customizing and tailoring content provided to the consumer according to the preferences of the consumer, based on observed behavior of the consumer.

While for purposes of simplicity of explanation, the respective processes are shown and described as a series of blocks in FIG. 2J, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

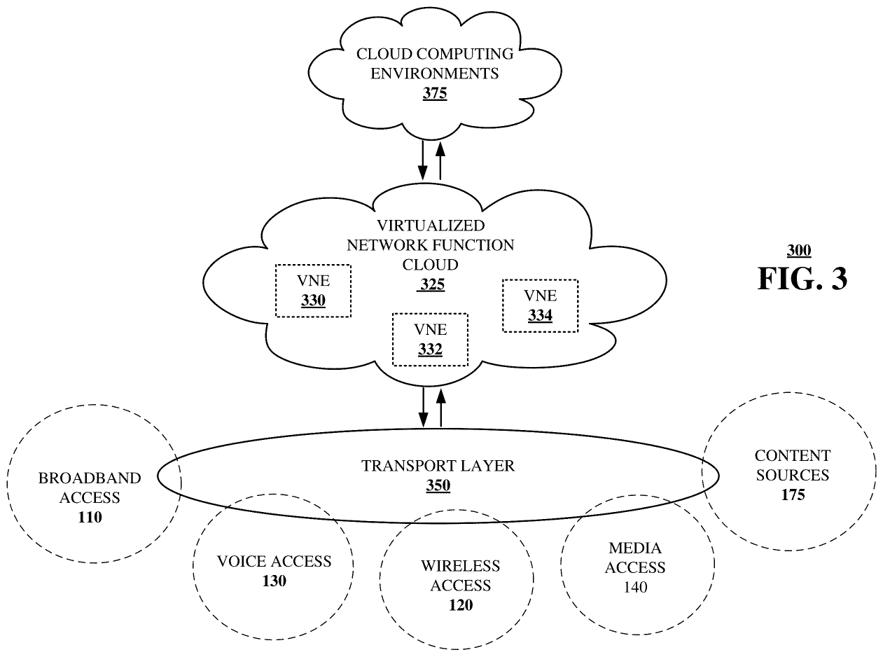

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 204, and method 230 presented in FIG. 1, FIG. 2A, FIG. 2B, FIG. 2D, FIG. 2E, FIG. 2F, FIG. 2G, FIG. 2H, FIG. 2I, FIG. 2J and FIG. 3. For example, virtualized communication network 300 can facilitate in whole or in part collecting information about how a user consumes and interacts with content items including interpersonal interactions and using the collected information to select and modify future content items sent to the user to tailor the provided content to the user's preferences.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

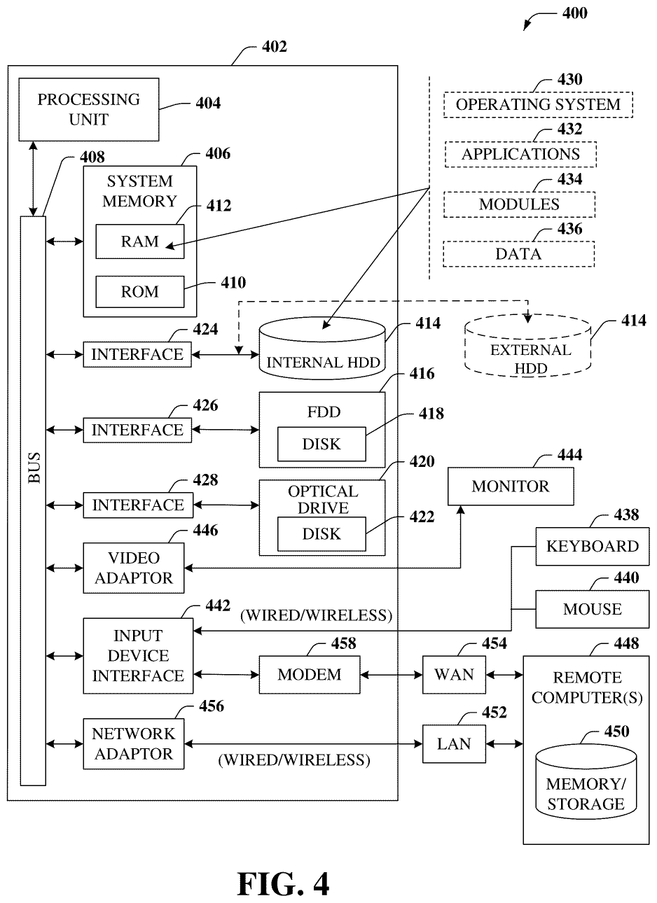

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part collecting information about how a user consumes and interacts with content items including interpersonal interactions and using the collected information to select and modify future content items sent to the user to tailor the provided content to the user's preferences.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part collecting information about how a user consumes and interacts with content items including interpersonal interactions and using the collected information to select and modify future content items sent to the user to tailor the provided content to the user's preferences. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

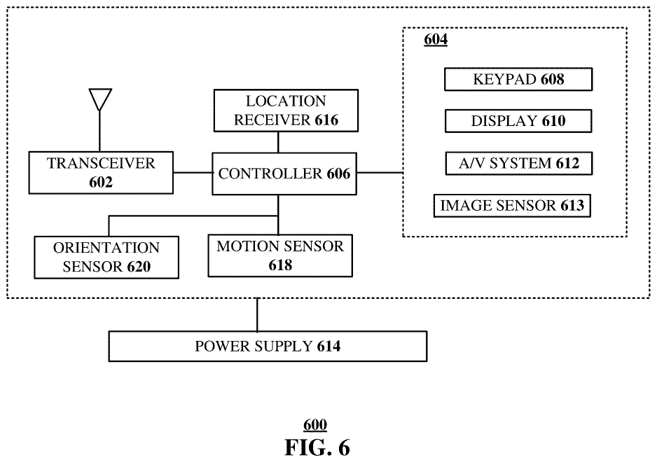

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part collecting information about how a user consumes and interacts with content items including interpersonal interactions and using the collected information to select and modify future content items sent to the user at a user device such as the communication device 600 to tailor the provided content to the user's preferences.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, data describing a consumption of first content data by a user at a user device;
determining, by the processing system, content style preferences of the user, wherein the determining the content style preferences for the user is based on the data describing the consumption of the first content data by the user;
receiving, by the processing system, second content data for the user; and
modifying, by the processing system, the second content data for the user, forming a modified content item, wherein the modifying the second content data is based on the content style preferences of the user.

2. The method of claim 1, comprising:
providing, by the processing system, the first content data to the user at a user device.

3. The method of claim 2, comprising:
providing, by the processing system, the modified content item to the user at the user device.

4. The method of claim 1, wherein the receiving data describing the consumption of the first content data by the user at the user device comprises:
receiving, by the processing system, sensor information from one or more sensors, wherein the sensor information from the one or more sensors includes information about awareness of the user of the first content data or information about reaction of the user to the first content data, or both.

5. The method of claim 4, wherein the receiving sensor information from the one or more sensors comprises:
receiving, by the processing system, first information from one or more on-board sensors of the user device; and
receiving, by the processing system, second information from one or more ambient sensors in an environment of the user.

6. The method of claim 1, wherein the determining the content style preferences of the user comprises:
providing, by the processing system, the first content data for forming a display of a first content item to the user at a user device;
identifying, by the processing system, two or more sub-elements of the display of the first content item;
determining, by the processing system, a relative affinity of the user for each respective sub-element of the two or more sub-elements of the display of the first content item; and
determining, by the processing system, the content style preferences of the user based on the relative affinity of the user for the respective sub-elements of the two or more sub-elements of the display.

7. The method of claim 6, wherein the determining the relative affinity of the user for each respective sub-element of the two or more sub-elements of the display comprises:
determining, by the processing system, a heat map for the display of the first content item, wherein the heat map indicates areas of greater interest by the user in the two or more sub-elements of the display and areas of lesser interest by the user in the two or more sub-elements of the display.

8. The method of claim 7, wherein the receiving data describing the consumption of the first content data by the user at the user device comprises:
receiving, by the processing system, gaze data for the user and the first content data, the gaze data based on information tracking a user eyeball position to locate a gaze of the user on the display of the first content item to the user at the user device; and
determining, by the processing system, the heat map based on the gaze data for the user and the first content data.

9. The method of claim 1, wherein the receiving the data describing the consumption of the first content data by the user at the user device comprises:
receiving, by the processing system, information about consumption by the user of one or more of audio data, video data, text data, web page content data and non-electronic content data.

10. The method of claim 1, comprising:
selecting, by the processing system, the second content data for the user based on the content style preferences of the user, forming selected content data; and
providing, by the processing system, the selected content data to the user device over a communication network.

11. A device, comprising:
a processing system including a processor; and
a memory that stores executable instructions that, when executed by the processing system, facilitate performance of operations, the operations comprising:
providing, over a communication network, a first content item to a user in an environment;
receiving, from a plurality of sensors in the environment of the user, information about a consumption of the first content item by the user;
based on the information about the consumption of the first content item by the user, determining content style preferences of the user;
receiving a second content item for the user;
modifying the second content item for the user, forming a modified content item, wherein the modifying the second content item is based on the content style preferences of the user to improve attractiveness of the second content item to the user; and
providing, over the communication network, the modified content item to the user.

12. The device of claim 11, wherein the receiving information about the consumption of the first content item by the user comprises:
receiving, from onboard sensors of a user device of the user, information about a type of media consumed in the first content item by the user, wherein the type of media comprises one or more of audio data, video data, text data, web page content data and non-electronic content data; and
modifying the second content item for the user to have a type of media matching the type of media consumed in the first content item by the user.

13. The device of claim 12, wherein the operations further comprise:
providing the first content item for display of the first content item to the user at the user device, the first content item including first content having a first media type and a second content having a second media type, the second media type being different from the first media type;
identifying two or more sub-elements of the display of the first content item, each respective sub-element corresponding to one of the first content and the second content;
determining a respective media type for each respective sub-element of the display;
determining content type preference information for the user, including determining how frequently the user selects content items having the first media type and determining how frequently the user selects content items having the second media type; and
determining the content style preferences of the user based on the content type preference information.

14. The device of claim 13, wherein the operations further comprise:
for each respective sub-element of the two or more sub-elements of the display, determining a respective gaze duration for the user viewing the respective sub-element of the display;
based on the respective gaze duration for the user viewing the respective sub-element of the display, determining a relative affinity of the user for each respective sub-element of the two or more sub-elements of the display; and
determining the content style preferences of the user based on the relative affinity of the user for each respective sub-element of the two or more sub-elements of the display.

15. The device of claim 11, wherein the receiving from the plurality of sensors in the environment of the user, information about a consumption of the first content item by the user comprises:
receiving user device interaction information from one or more onboard sensors of a user device of the user, the user device operative to receive the first content item over the communication network and to display the first content item to the user;
receiving, from environmental sensors in the environment, user personal interaction information for the user, the user personal interaction information reflecting a person-to-person interaction by the user with another person; and
determining content style preferences of the user based on the user device interaction information and the user personal interaction information for the user.

16. A non-transitory machine-readable medium, comprising executable instructions that, when executed by a processing system including a processor, facilitate performance of operations, the operations comprising:
providing, over a communication network, a first content item to a user in an environment;
receiving, from a plurality of sensors proximate the user, information about a consumption of the first content item by the user;
storing, in a content consumption database, the information about the consumption of the first content item by the user;
retrieving, from the content consumption database, the information about the consumption of the first content item by the user;
retrieving, from the content consumption database, additional content consumption information for the user, the additional content consumption information relating to other consumption of other content items by the user;
determining content style preferences of the user, wherein the determining the content style preferences of the user is based on the information about the consumption of the first content item by the user and the additional content consumption information;
receiving a second content item for communication to the user;
modifying the second content item for the user, forming a modified content item, wherein the modifying the second content item is based on the content style preferences of the user to improve attractiveness of the second content item to the user; and
providing, over the communication network, the modified content item to the user.

17. The non-transitory machine-readable medium of claim 16, wherein the operations further comprise:
selecting the second content item for the user, wherein the selecting is based on the content style preferences of the user, forming a selected content item; and
providing the selected content item to a user device of the user over a communication network.

18. The non-transitory machine-readable medium of claim 16, wherein the operations further comprise:
providing the first content item to the user, over the communication network, to a user device of the user;
receiving the information about the consumption of the first content item by the user from one or more onboard sensors of the user device of the user;
storing sensor information about the one or more onboard sensors of the user device of the user in a sensor registration database; and
storing the information about the consumption of the first content item in the content consumption database in association with the additional content consumption information for the user and other content items.

19. The non-transitory machine-readable medium of claim 18, wherein the operations further comprise:
analyzing the information about the consumption of the first content item and the additional content consumption information for the user to determine the content style preferences of the user; and
storing information about the content style preferences of the user in a user content style preferences database.

20. The non-transitory machine-readable medium of claim 16, wherein the determining the content style preferences of the user comprises:
determining a preferred dialog type for the user when communicating by the user with other persons;
determining a user vernacular when communicating by the user with other persons;
determining a preference for the user between consuming text content and image content; and
determining a preference for the user for a type of imagery in content items.
